(19) United States
(12) Patent Application Publication
(10) Pub. No.: US 2005/0288853 A1
(43) Pub. Date: Dec. 29, 2005

(54) Method for automated text placement for contour maps and chart

(76) Inventor: Weiping Yang, West Windsor, NJ (US)

Correspondence Address: Arthur M. Peslak, Esq.;MANDEL & PESLAK, LLC, Suite 5, 80 Scenic Drive, Freehold, NJ, 07728, US

(21) Appl. No.: 10/879,844

(22) Filed: Jun. 29, 2004

(51) Int. Cl. G01C 21/30; G06F 17/00

(52) U.S. Cl. 701/208; 342/357.13; 707/100

(57) ABSTRACT

A method for automatically placing textual information (labels) on contour maps according to modern cartographic conventions is described. A three-step process is used: in the first step contours are organized into a contour tree (a special data structure) comprised of contour groups. Each group serves as a node in the tree and corresponds to a terrain structure. The second step devises profiles emitted from the peak of a group in a discrete number of directions. Only contours intersected by a profile, and the intersections presenting a monotone curve on the surface of a single terrain structure, are associated with the profile. A processed profile serves as the basis for an array of contour labels which are aligned along the profile. The cartographic merit of every profile is evaluated during this step. The final step renders the positions of contour labels along a profile which is taken by its merit value. Constraints such as the distance between multiple labels of a contour, the reversing of reading directions of a label allowed on a non-standard profile, and the criterion for conflict-free placement play critical roles in the selection of a label.

### FIELD OF THE INVENTION

This invention relates to the computation and cartographically informative placement of contour labels (elevation information) on a cartographic map or chart. In particular, the invention provides an automated method of calculating the location of contour labels in a way that the layout of the labels conveys important terrain information that is easy to interpret and provides the highest aesthetic and cartographic quality possible. The automated methods based on this invention may be used in Geographic Information Systems (GIS).

### BACKGROUND OF THE INVENTION

Contours are a special kind of 2-dimensional isolines which are widely used for portraying relief of the terrain by associating elevation with every contour. In digital mapping, the elevation is stored as an attribute of the contour. It is desirable for the users of a contour map to label the elevation against contour lines to aid the comprehension of the terrain structures and to facilitate the interpretation of the elevation at any point. The present invention is directed to an automated approach to label contours following modern cartographic conventions.

With the advance of digital terrain modeling techniques, contour maps can be generated and stored within a GIS as a distinct layer or feature class, whose attribute fields can be accessed through SQL-like queries. The contour labeling capability has been claimed by commercial GIS systems (e.g. Autodesk Land Desktop 2004) and non-commercial research projects (e.g. NCAR Graphics' Contour Plot Package in HLU). There are, however, few publications explaining the methods utilized by those tools.

The algorithms developed based on the present invention are integral components of a software package Label-EZ™ that automatically places text on maps and charts. Label-EZ™ is a standalone software system requiring an interface and access to a GIS system. In prior versions of Label-EZ™, contour labeling was handled by the same method as the one that labels streets without special rules with respect to cartographic conventions for contour labeling. Because of this, contour labels were not presented in a coherent way to portray terrain features. An object of the present invention is to overcome these shortcomings in the prior software.

Since GIS systems do not preserve spatial structures that are described by elevation/depth contours, one important challenge facing automated contour line labeling is to identify the groups of contours that together describe a distinct terrain feature. The problem was first attacked in the 1960s when a formal topological model and the storage structures of contour lines were discussed by those of ordinary skill in the art. These principles were applied to a surface structure and named a contour tree. The conceptual model of contour trees has been widely used for identifying contour line works converted from scanned images for the purpose of assigning elevation values for contours.

### SUMMARY OF THE INVENTION

Given a vector contour map accessible from a GIS where contour lines are stored individually with no explicit relationships, the present invention provides a method of automatically labeling the contour map with a predefined label positioning and placement convention. The general objects of the present invention are to
1. Find the cartographic relationships among contour lines based on their elevations and neighborhood relations; and
2. Develop a method for a coordinated label placement for the contours so that the result conforms to the highest cartographic standards.

Specifically, the invention is aimed at satisfying the following objectives:
1. The data structure developed should handle normal contour lines (they are closed within a map extent) and contours that are extended to map boundaries and those that are broken within map boundaries (as a scanned result).
2. The data structures for the topology should be preserved for post placement editing.
3. The placement of contour labels should conform to cartographic conventions (e.g. labels should be in normal reading directions from west to east, and mountain labels should “step up to the peak” while basin labels should “step down to the bottom”).
4. The methods should also allow placing contour labels in an unconventional way, that is mountain labels may be placed as “step down” with a reversed (upside-down) reading direction, and basin labels may be placed as “step up” with a reversed reading direction.
5. Contours of a single terrain structure may be labeled more than once. The minimum distance between labels of the same contour can be controlled by the user.
6. The placement should avoid overlapping of labels.

The method consists of three steps as illustrated in FIG. 5:
1. The present invention organizes contours into a contour tree comprised of contour groups. Each of the groups serves as a node in the tree and corresponds to a terrain structure on the ground as shown in FIG. 6.
2. The present invention then devises profiles emitted from the peak of a group in a discrete number of directions. Only contours intersected by a profile, and the intersections presenting a monotone curve on the surface of a single terrain structure, are associated with the profile. A processed profile serves as the basis for an array of contour labels which are aligned along the profile. The merit of every profile is evaluated during the step as shown in FIG. 7.
3. The present invention renders the positions of contour labels along a profile which is taken by its merit value. Constraints such as the distance between multiple labels of a contour, the reversing of reading directions of a label allowed on a non-standard profile, and the conflicting control are observed in the selection of a label. This step is illustrated in FIG. 8.

### BRIEF DESCRIPTION OF THE FIGURES

FIG. 1 depicts typical terrain structures to be processed with the present invention.

FIG. 2(a), (b), and (c) illustrate special cases of contour maps.

FIG. 3 illustrates contour labeling with normal reading direction.

FIG. 4 illustrates labeling with reverse reading direction.

FIG. 5 illustrates a block diagram and data flow in the contour labeling subsystem.

FIG. 6 illustrates the data flow of grouping contours.

FIG. 7 illustrates the data flow of profiling contour groups.

FIG. 8 illustrates the data flow of placing labels.

FIG. 9 depicts the relationships between structures for contour labeling.

FIG. 10 illustrates the design of profiles.

FIG. 11 illustrates the selection of an optimal profile by probing for a better profile.

FIG. 12 shows a disordered contour list due to broken contours.

FIG. 13 illustrates the separation of an island and its bank.

FIG. 14 illustrates how plateaus are detected and grouped into different contour group than the neighboring mountain

FIG. 15 illustrates how the quality of a profile is determined by excluding those profile candidates that cross sibling terrain features (blockages).

### DETAILED DESCRIPTION OF THE INVENTION

The present invention will now be described in connection with its presently preferred embodiment as illustrated in the appended drawings. Those of ordinary skill in the art will understand that the scope of the present invention is not limited by the description herein.

Contour lines are a special kind of cartographic feature and their labeling requires the understanding of their relational characteristics and other geomorphologic considerations.

1 Overview

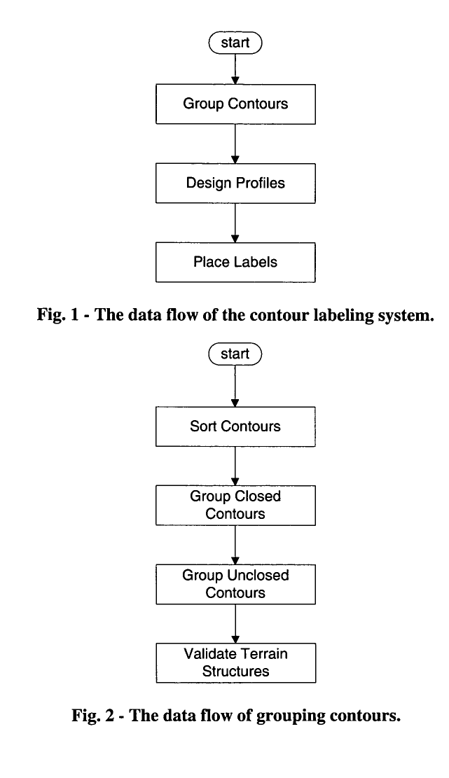

Contour lines on a map describe forms and structures of the corresponding terrain. Each contour represents all points of the same elevation/depth for a terrain feature. A group of similar contours collectively illustrates the change of elevation and hence the form of a mountain or a basin. The larger the elevation, the shorter the contour line for a mountain, and vice versa for a basin. At the summit of a mountain or at the bottom of a basin, the contours degenerate into peaks which are often represented by crosses or triangles. A map may have a number of groups of contour lines to represent different mountains and basins. Contour lines may get merged at the foot of mountains but may never cross. Mountains or basins may have ridges where two sloping surfaces meet. The curvature of contours along the ridge changes directions. Peak, foot, ridge, and sloping surface are important characteristic structures useful to placing and aligning contour labels, as shown in FIG. 1.

In theory, all contour lines must be closed lines and all contours must be contained within other contours of the same terrain structure, except for the contours representing the foot. In practice, contour data may not come as clean as needed. Due to errors in digitization, one or more gaps may exist in a contour, ending up with unclosed contours. FIG. 2 illustrates some of the special problems seen in contour maps.

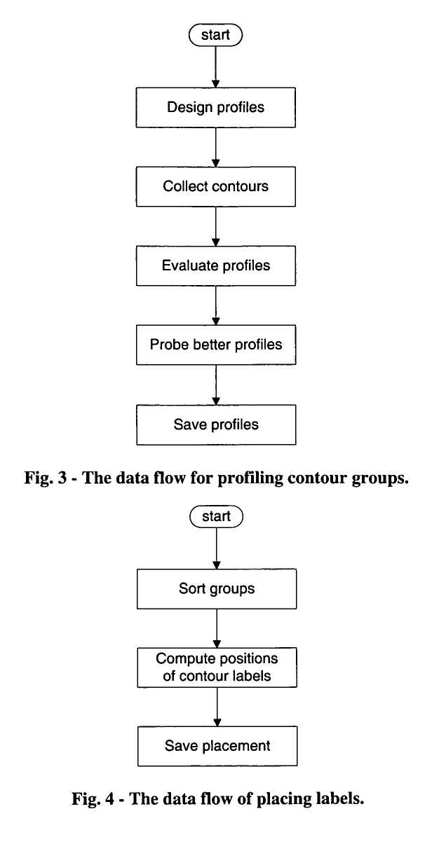

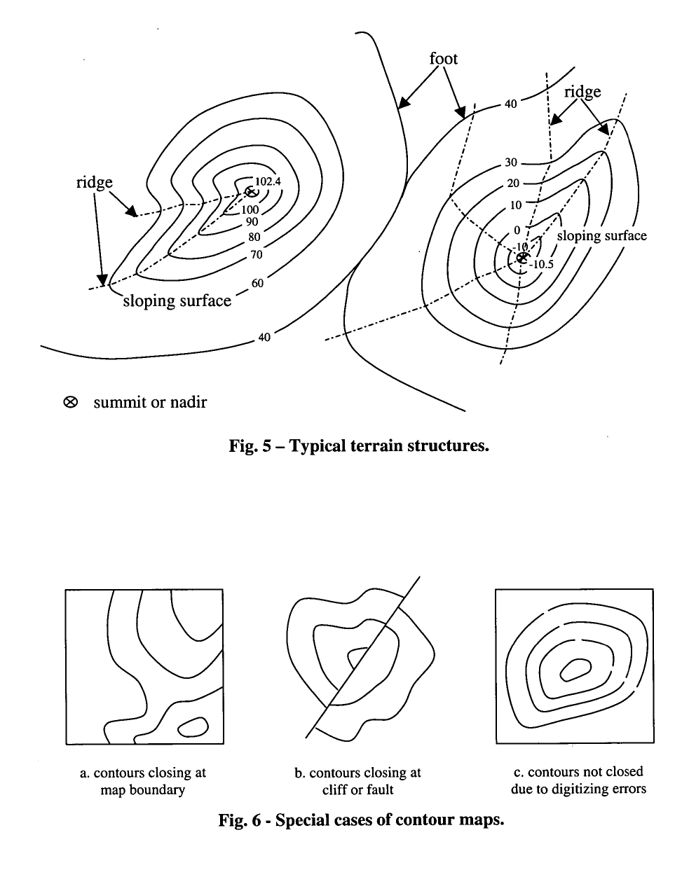

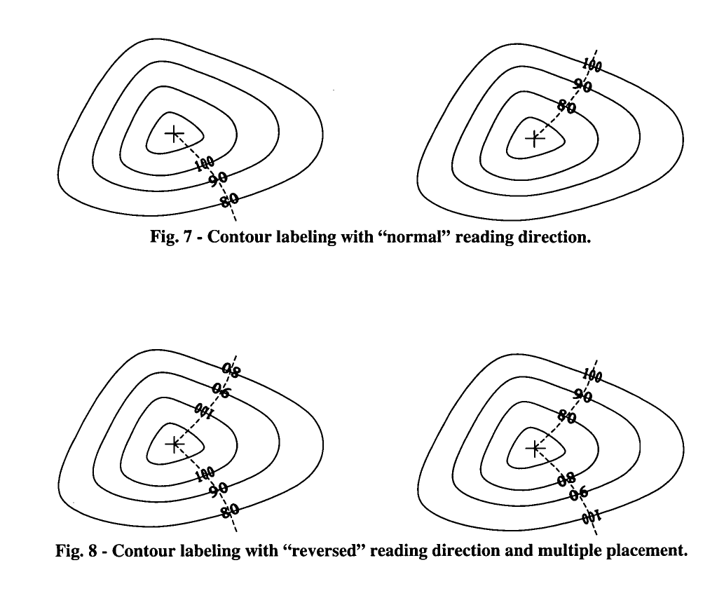

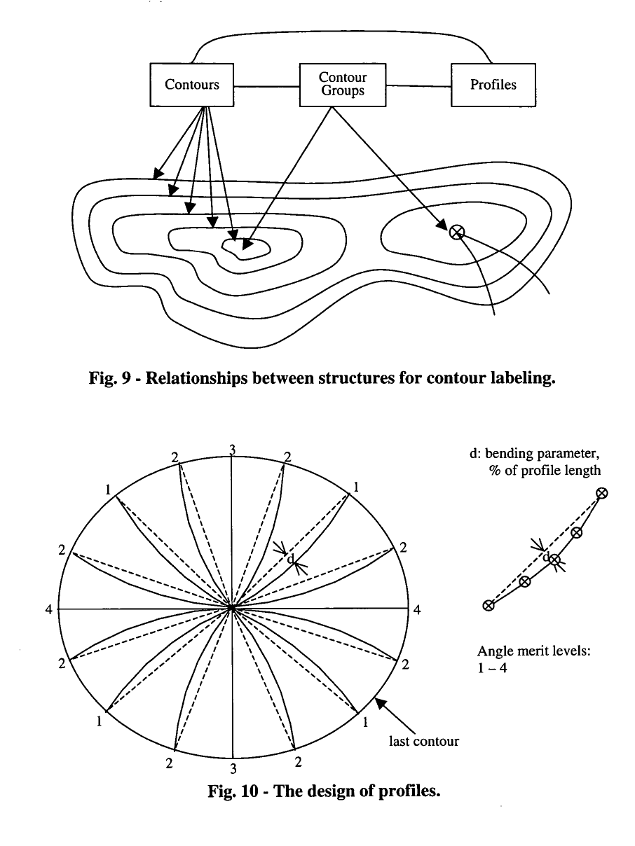

According to cartographic convention, contour labels are normally placed “upward” or “downward”. As shown in FIG. 3, the labels for a mountain are stepping up with the top edges of text facing the peak, and the labels for a basin are stepping down with the bottom edges of text facing the peak. Thus, the labels for a mountain are generally placed below the horizon and those for a basin above the horizon.

In practice, contour labels may also be required on the opposite side of the horizon, however, with a reversed reading direction. FIG. 4 illustrates how contour labels for a mountain are placed above the horizon, but with the reading direction reversed so the labels become upside-down. Similarly, the basin labels are placed upside-down below the horizon.

The upside-down contour labeling may be applied in two circumstances: (1) multi-placement when arrays of labels can be placed at both normal and reversed positions, and (2) single placement when an array of labels cannot be placed at normal positions (e.g. because of a difficult shape of contours, or the normal positions of the contour group are cut off by the borders of the map).

In addition, it is preferable to have the array of contour labels to align in slightly curved lines (shown as dashed-lines in FIG. 3 and FIG. 4, respectively).

2 Labeling Elevation Contours

As discussed above, contour features are a very special kind of line features and their labeling requires procedures not currently available in software packages. The following processes are required to label contours, considering their group features.
1) Finding contour lines belonging to the same distinct terrain structures which will form structural groups of contours.
2) For each group of contours, determining a profiling curve from peak to foot which has the least slope change.
3) Designing execution keywords and executing loops which handle a group of contours at one time.
4) Placing contour labels along profiling curves.
5) Designing output format to distinguish contour records in lab file.
6) Designing procedures to display and edit contour labels and performing masking/unmasking underneath the background graphics.

The approach for each step is described in further detail below.

2.1 Group Contours of the Same Terrain Structure

A. Sort Contours in Order of Elevation

This step takes every contour line and inserts it into a sorted list of contours, implemented by a double-linked-list. The contours of higher elevations will be listed first. When two contours have a same elevation, the firstly processed contour will be listed first. For reference, the sorted contour list, starting from the highest elevation is named descendingContours. The status of any contour in descendingContours is “unprocessed” at this time. The last contour in the list has the lowest elevation and it points back to contours of higher elevation. The present invention name reverses the linked list as ascendingContours.

B. Grouping contours of the Same Terrain Structure

This step involves the following sub-steps:
a. Grouping contours, one-by-one taken from descendingContours, which are closed within the extent of the map. Mark the status of any closed contours as “processed”. The grouping process is elaborated below (B.1). It is noted that more than one contour group may be found enclosed by a closed contour.

b. Grouping contours, one-by-one taken from the descendingContours, which are not closed within the extent of the map. This step includes contours that are cut by the boundary lines and contours that are broken during digitization. If a contour is unclosed, it is likely that the contour cannot be determined to be part of any contour group, and therefore will form a group by itself. For this reason, the status of an unclosed contour is not marked. Additional process will be used to further determine whether the unclosed contour is associated with any groups.

B.1 The Grouping of Contours Comprises the Following Steps
a. Locating enclosing groups of a given contour.
b. If groups are found enclosed, then the given contour is appended to the contour list of every found group and associating the list of contour groups to the contour.
c. If no group is found, it is necessary to check whether it contains any contours of lower elevations, which may form contour groups for basins. The sub steps for determining basin groups are described below in B.1.1.
d. If no group is found, then a new contour group for a mountain is created, with the given contour as the first contour of the group.

B.1.1 Determining any Basin Groups Comprises the Following Steps:
a. Determining the elevation of the current contour.
b. Taking a testing contour from the reversed sorted list, starting from ascendingContours,
c. If the elevation of the testing contour is equal or higher than that of the current contour, exit with any basin groups found in the process.
d. If a testing contour is found to be enclosed by the current contour (testA), continue checking if the testing contour is enclosing any basin groups created in this process (testB). If testA is true and testB is false, a new contour group is created for a basin, with the testing contour as the first contour of the group. If testA is true and testB is also true, the testing contour is attached to the basin group. The status of the testing contours whose group association is determined as “processed” is marked.
e. Taking a next contour and repeating steps (c) and (d).
f. Exiting with any basin groups found in this process.

C. Validating the Terrain Structure of Each Group

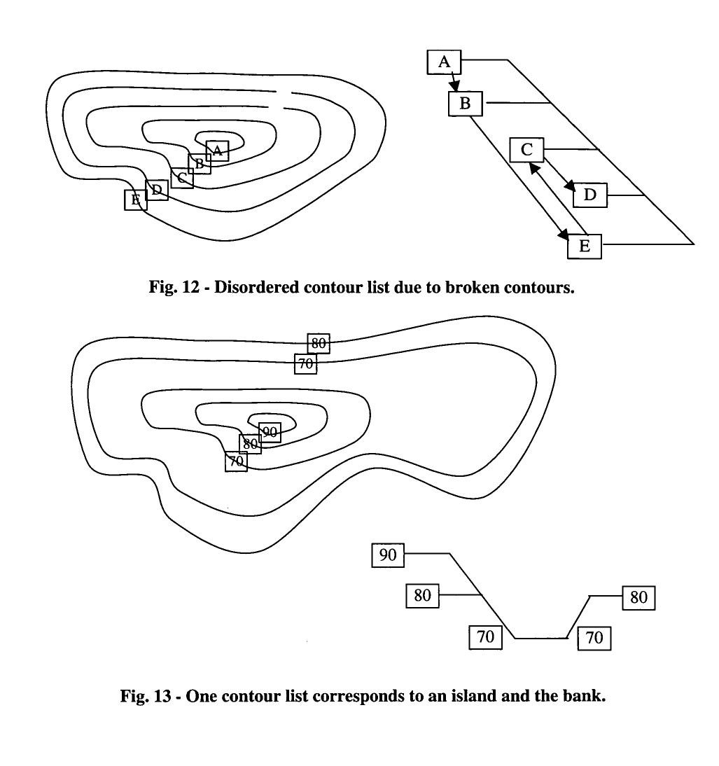

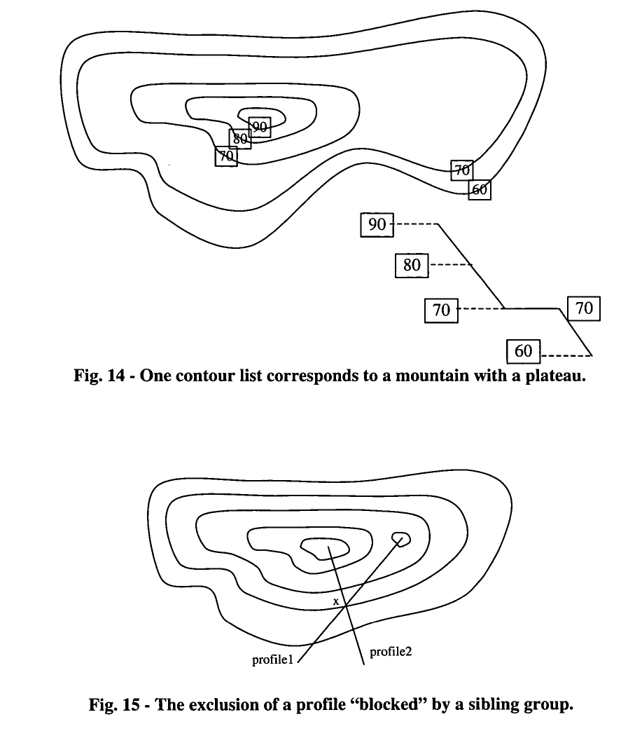

This step checks the monotone property of a contour group with respect to its terrain structure. For the purpose of labeling contours, it is asserted that the contour list forms a monotone profile descending or ascending in elevation. No fluctuations should be allowed. Labeling contours by the unit of monotone structures can help to recognize terrestrial complexities. When contour groups are constructed by appending contours to the enclosing groups, their terrain structures are not checked. The monotone property may not be preserved due to the following situations:
Because of the 2-pass process, first for the closed contours and the second for the open ones, it is possible that a closed contour of lower elevation is appended to the group contour list before the group's open contours with higher elevations (FIG. 12).
An island and its bank have been listed as a group (FIG. 13), which should be separated.
When plateaus are present on the surface of a mountain or a basin, a fluctuation occurs, that could be overlooked (FIG. 14). The features should be separated and grouped into different contour groups because they represent different terrain features.

The above situations should be identified. For the first situation, the involved list items should be swapped to represent a monotone terrain structure. For the second and the third situations, the list should be split to form two contour groups.

2.2 Profiling Contour Groups

2.2.1 Design Profiles

A maximum number of 16 profiles are used for placing candidate contour labels for a group. Depending on the user's desire, profiles above the horizon of a mountain and those below the horizon of a basin may not be needed. This step determines whether profiles for upside-down labels are needed. It also designs slightly curved lines for candidate profiles, with a bending parameter, d, given by users as shown in FIG. 10. Each profile is composed of 5 equally distanced vertices, with the first being at the peak and the last at the intersection with the last contour.

2.2.2 Collect Contours

Due to the complexity of terrain structures, not all profiles will cross the same number of contours, and the geometrical situations of these crosses can also vary from profile to profile. In this step, the data describing contours crossed by a profile is computed and saved, which will be used to evaluate the quality of a profile.

When profiling a group of contours which have sibling contour groups, a profile line may cross the terrain structure of the sibling group. This can produce unpleasant contour labels of more than one terrain structures. To determine whether a sibling contour group forms a blockage at the testing contour, we use two profiles, one from the current group, call profile1, and the other from the sibling group, call profile2. The determination depends on two factors: the distances from the two peaks to the intersection m, and the intersection angles at m as shown in FIG. 15.

2.2.3 Evaluate Profiles

This step computes the merit value of a profile composed of contours. The factors contributing to the “merit” of a profile include:
a. The angle of the profile. There are deductions on the merit for any profiles near horizontal or vertical.
b. The number of contours in the profile.
c. The inflection angle of the profile line with a contour.
d. The reading direction of a contour label.
e. The distances between contour intersections on the profile, referred to as gaps.
f. The discrepancy of the gaps compared with the average gap on the profile.
g. The smoothness of the contour section (approximately the length of a contour label) crossing the profile.

2.2.4 Probe a Better Profile

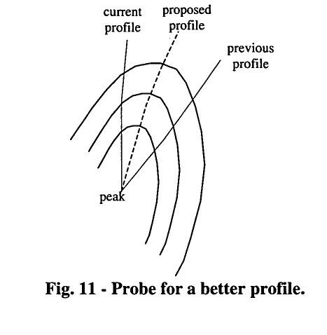

If the current profile and the previous profile have average inflection angles opposite in sign, there might be a better profile in between as shown in FIG. 11. A new candidate profile should then be proposed and the merit value computed.

2.2.5 Save Profiles

The current profile is inserted into the profile list of the contour group, ordered by their merit value.

2.3 Placing Contour Labels Along Best Profiles

2.3.1 Sort Groups by the Maximum Number of Contours

At this stage, all candidate profiles are computed and saved to all groups. This step counts the maximum number of the contours from all profiles of a group, and then sorts the groups in descending order from the maximum number.

2.3.2 Calculate the Positions of Labels

The placement of contour labels loops through the sorted groups. With each group, the best profile is processed first. The process then takes the next group, and places labels for the next best profiles, and continues until all data is processed. For each profile, the following steps are taken:
A: Looping through the contours of the profile.
B: For each contour, computing the points of the contour section on both sides of the profile. The start and end points should be directed to the reading direction of the contour label.
C: Creating the text boxes centered at the intersection, and against the shape of the contour section.
D: Checking any overlaps of the text boxes against previously placed labels. Drop the label if overlap occurs.

2.3.3 Save Labels

Finally, the computed label positions are saved back into the map for display.

Those of ordinary skill in the art will recognize that the foregoing description merely illustrates an embodiment of the present invention and many modifications may be made thereto without departing from the spirit or scope of the present invention as set forth in the following claims.

1. A method of grouping contours based on their associated terrain structures comprising the steps of:
a) Sorting a plurality of contours in order of descending elevation for mountains and in order of ascending elevation for basins into a double-linked-list wherein the double-linked list is a data structure stored in memory;
b) Grouping contours from the double-linked-list by checking a containment relationship between contours whereby the grouping processes the contours that are closed within an extent of a map first, and then the contours that are not closed within an extent of a map; and
c) Validating the contour groups by checking the monotone property of group profiles.

2. A method of generating profiles for a contour group comprising the steps of:
a) Providing a plurality of profiles up to a maximum number of 16;
b) Finding intersections of the plurality of contours in the group with the profile line whereby only intersected contours will be associated with the profile;
c) When a contour can be associated with two profiles belonging to sibling groups, checking if adding the contour into one of the plurality of profiles will form a “blockage” of one of the other profiles;
d) Evaluating the plurality of profiles by computing a merit value of a profile using the intersection data computed and saved in Step b;
e) Determining whether each profile and a previous profile have average inflection values opposite in sign and if so a new profile is proposed and Steps B to D are repeated, and;
f) Saving each profile ordered by the merit value assigned in Step D;

3. A method of placing a plurality of elevation/depth labels along a profile in a coordinated fashion, comprising the steps of:
a. Reasonably aligning the plurality of labels by connecting individual labels that cross the profile generally in a perpendicular fashion;
b. Checking overlaps between neighboring labels to avoid any overlaps, and;
c. Selecting an optimal profile of labels is and saving by evaluating several candidate profiles by their cartographic merit values.

4. A method to convey cartographic terrain elevation/depth information comprising the steps of:
a. Placing labels in a normal reading direction; and
b. Placing labels in a reversed reading direction.

5. A data structure comprising:
a. contour groups;
b. contours; and
c. profiles.
